(19) United States
(12) Patent Application Publication
(10) Pub. No.: US 2015/0186018 A1
(43) Pub. Date: Jul. 2, 2015

(54) ELECTRONIC APPARATUS, TOUCH SELECTION METHOD, AND NON-TRANSITORY COMPUTER READABLE MEDIUM

(71) Applicant: HTC Corporation, Taoyuan County (TW)

(72) Inventors: Sheng-Jie LUO, Taoyuan County (TW); Liang-Kang HUANG, Taoyuan County (TW); Tzu-Hao KUO, Taoyuan County (TW)

(21) Appl. No.: 14/583,205

(22) Filed: Dec. 26, 2014

Related U.S. Application Data
(60) Provisional application No. 61/920,775, filed on Dec. 26, 2013.

(51) Int. Cl. G06F 3/0484; G06F 3/0488

(52) U.S. Cl. CPC G06F 3/04845; G06F 3/04842; G06F 3/04883

(57) ABSTRACT

A touch selection method, an electronic apparatus, and a non-transitory computer readable medium are disclosed herein. The touch selection method is able to perform a touch selection on a display of an electronic apparatus, in which the display displays content. The touch selection method includes following operations: assigning a selection unit corresponding to one of zoom levels, in which the selection unit includes pixels on the display that are regarded as a minimum selectable component for the touch selection.

This application claims priority to U.S. provisional application Ser. No. 61/920,775, filed Dec. 26, 2013, which is herein incorporated by reference.

### BACKGROUND

1. Technical Field

The present application relates to a touch selection method for electronic apparatus. More particularly, the present application relates to a touch selection method on multi-level selection.

2. Description of Related Art

Recently, electronic devices, such as mobile phones, personal digital assistants (PDAs), tablet computers, and the like, have become more and more technically advanced and multifunctional.

Electronic devices are usually implemented with a touch screen to allow users perform related operations. For example, users are able to select a character, a word, or even a paragraph on a text by manipulating on the touch screen. However, the present user interfaces require users to combine several selections on characters or words (i.e., low selection units) to select the paragraph (i.e., high selection units), resulting in trivial tasks on the users. The users' operation efficiency is reduced, and users' experience is thus limited.

Therefore, a heretofore-unaddressed need exists to address the aforementioned deficiencies and inadequacies.

### SUMMARY

An aspect of the present application is to provide a method for performing a touch selection on a display of an electronic apparatus. The method includes following operations: assigning a selection unit corresponding to one of zoom levels, in which the selection unit includes pixels on the display that are regarded as a minimum selectable component for the touch selection.

Another aspect of the present application is to provide an electronic apparatus that includes a display and a processing unit. The display is configured to receive a touch selection. The processing unit is configured to assign a selection unit corresponding to one of zoom levels, in which the selection unit includes pixels on the display that are regarded as a minimum selectable component for the touch selection.

Yet another aspect the present application is to provide a non-transitory computer readable medium having stored thereon executable instructions, that when executed by the processor of a computer control the computer to perform steps including: assigning a selection unit corresponding to one of the zoom levels, in which the selection unit comprises pixels on a display that are regarded as a minimum selectable component for a touch selection, the selection unit is different under the each of the zoom levels.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram of an electronic apparatus according to an embodiment of the disclosure;

FIG. 2 is a diagram illustrating the operation concept of the touch selection provided by the electronic apparatus according to an embodiment in the present disclosure;

FIG. 3 is a flow chart of a touch selection method of an electronic apparatus according to an embodiment of the disclosure;

FIG. 4A is a global view of an image on the content in FIG. 1 according to an embodiment of the disclosure;

FIG. 4B is a partial enlarged view of the image in FIG. 4A according to an embodiment of the disclosure;

FIG. 4C is a local view of an image in FIG. 4A according to an embodiment of the disclosure;

FIG. 5A is a global view of a text on the content in FIG. 1 according to an embodiment of the disclosure;

FIG. 5B is a partial enlarged view of the text in FIG. 5A according to an embodiment of the disclosure;

FIG. 5C is a further partial enlarged view of the text in FIG. 5A according to an embodiment of the disclosure; and

FIG. 5D is a local view of the text in FIG. 5A according to an embodiment of the disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

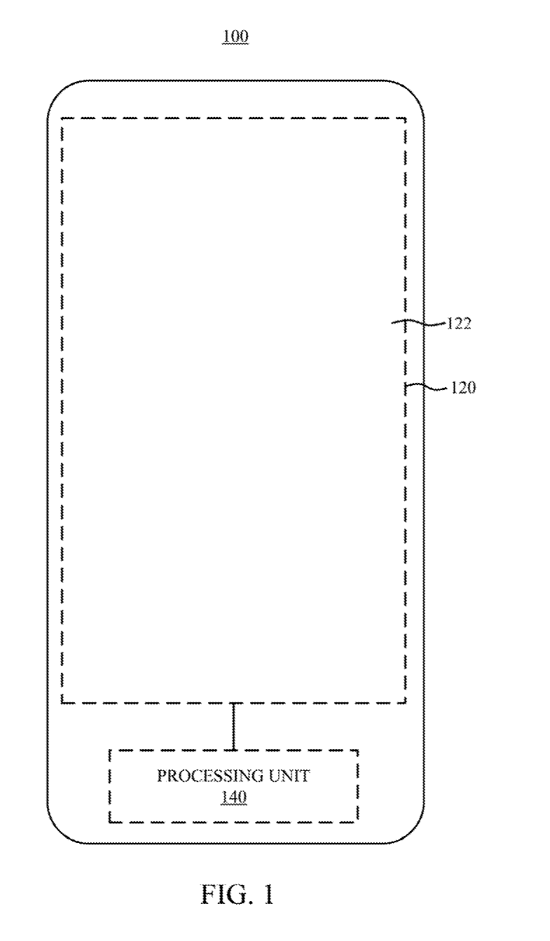

Reference is made to FIG. 1. FIG. 1 is a schematic diagram of an electronic apparatus 100 according to an embodiment of the disclosure. In various embodiments of the present disclosure, the electronic apparatus 100 is able to be a mobile phone, a smart phone, a tablet, a laptop, a personal computer, or an equivalent consumer electronics product.

As shown in FIG. 1, the electronic apparatus 100 includes a display 120 and a processing unit 140. The display 120 is configured to display content 122 to users and to receive a user input, e.g., a touch selection. The content 122 includes text, images, application programs, etc. In various embodiments, the display 120 includes a touch screen. Users are allowed to view the information on the content 122, and to perform certain manipulations on the content by tapping or drawing strokes on the touch screen.

For illustration, users are able to view the content 122 in more details by performing a zoom-in operation on the display 120. Alternatively, users are able to view the entire content 122 by performing a zoom-out operation on the display 120. Each zoom-in/out operation corresponds to one of a plurality of zoom levels, in which a minimum zoom level corresponds to a global view of the content 122 (i.e., the entire content 122 is able to be viewed), and a maximum zoom level corresponds to a local view of the content 122. The processing unit 140 is configured to select from the zoom levels in response to the user input as the current zoom level. Therefore, users are able to view and select desired objects in the content 122, such as text, image, etc, by performing the zoom-in/out operation and the touch selection on the display 120.

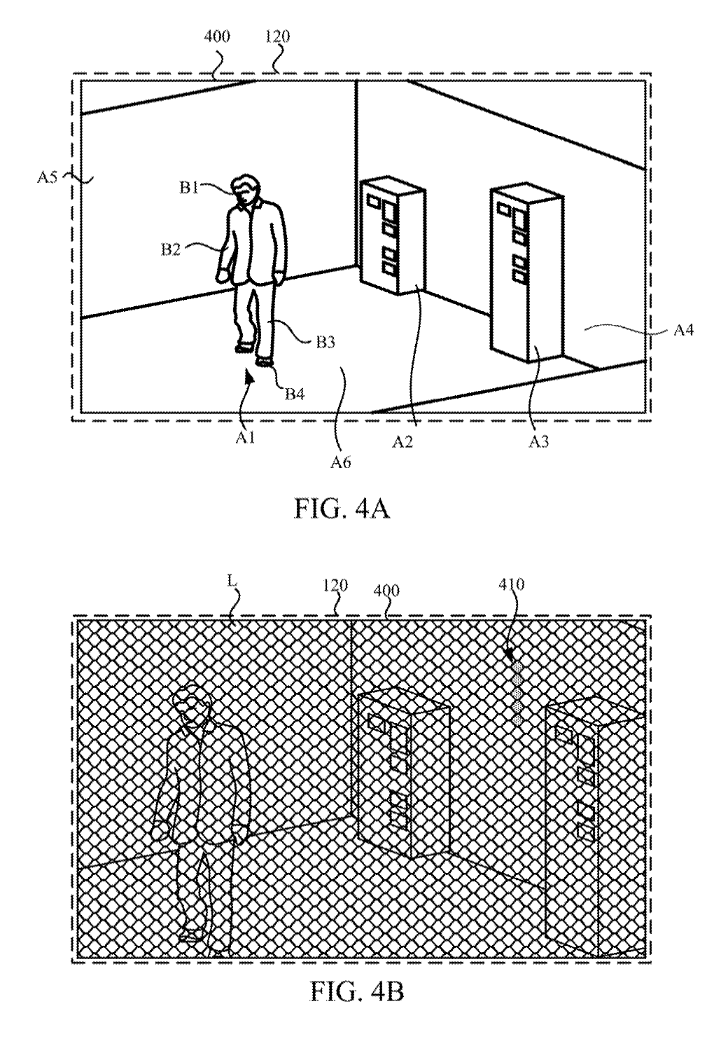

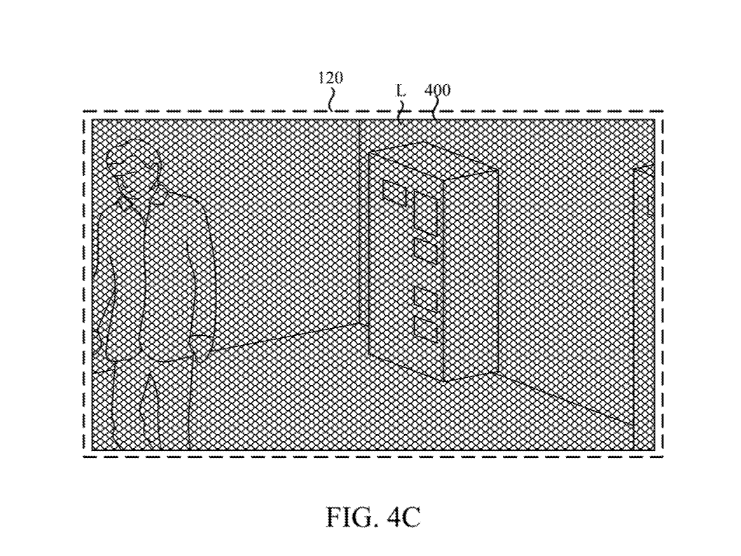

The processing unit 140 is configured to assign selection units (e.g. the selection units L in FIG. 4A-4C) corresponding to the current zoom level, and to make the display 120 zoom in or zoom out a view of the content 122 in response to the current zoom level. Each selection unit is defined as pixels on the display 120 that can be selected or deselected by one tapping/clicking/pressing on the display 120. For illustration, the selection unit can be regarded as a minimum selectable component/object/element of the content 122. To prevent users from trivial tasks on multi-level selection, the processing unit 140 is further configured to assign another selection unit when the zoom level is re-selected from user input. In other words, the processing unit 140 is able to map the current zoom level, which is used for presenting the content 122, to a corresponding selection unit. With such a configuration, the selection unit is different under each of the zoom levels, and users are able to select the desired objects in a much suitable selection unit when viewing the content 122 in a specific zoom level. Thus, the users' experience is improved.

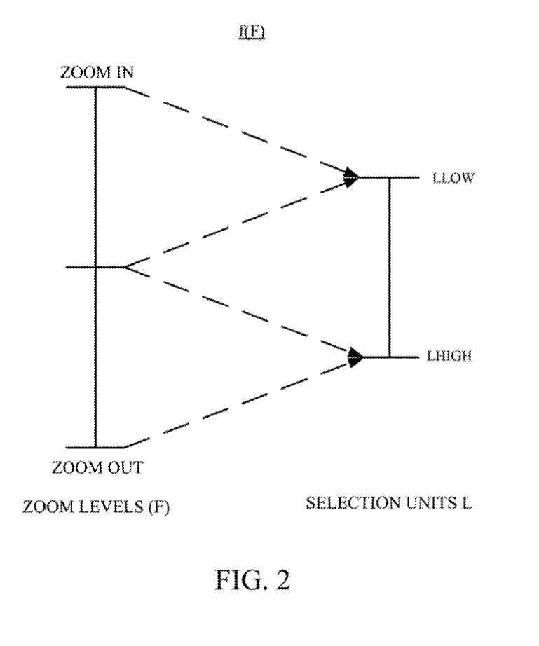

Reference is made to FIG. 2. FIG. 2 is a diagram illustrating the operation concept of the touch selection provided by the electronic apparatus 100 according to an embodiment in the present disclosure.

As shown in FIG. 2, the relationship between the zoom level F and the selection unit L is described as a mapping function f(F). For example, the content 122 is an image, and the image is assigned to have two selection units LHIGH and LLOW by the processing unit 140. In the higher selection unit LHIGH, the image is divided into regions with large size. In the lower selection unit LLOW, the image is divided into region with small size. The zoom levels F, which have different scales, are defined in the range of the minimum zoom level FMIN to the maximum zoom level FMAX. The processing unit 140 sets the range of the zoom level F into two parts and maps each part to one of the selection units LHIGH and LLOW by using the mapping function f(F) illustrated as equation (1) below. With the mapping function f(F), when users view the content 122 with a small zoom level F, users are able to manipulate a lager region. Alternatively, when users view the content 122 with a large zoom level F, users are able to manipulate a small region.

$$\{ \begin{matrix}f ( F ) = LHIGH , if FMIN \leq F \leq ( FMIN + FMAX ) \text{/} 2 \\ f ( F ) = LLOW , if ( FMIN + FMAX ) \leq F \leq FMAX\end{matrix} \qquad ( 1 )$$

The number and configuration of zoom levels F, selection units LHIGH and LLOW, and the mapping function f(F) in this disclosure is given for illustrative purposes. Various numbers and configurations of the zoom levels F, selection units, and the mapping function f(F) are within the contemplated scope of the present disclosure.

The following paragraphs in the present disclosure will provide certain embodiments, which are utilized to implement the functions and operations of the electronic apparatus 100. However, the present disclosure is not limited in the following embodiments.

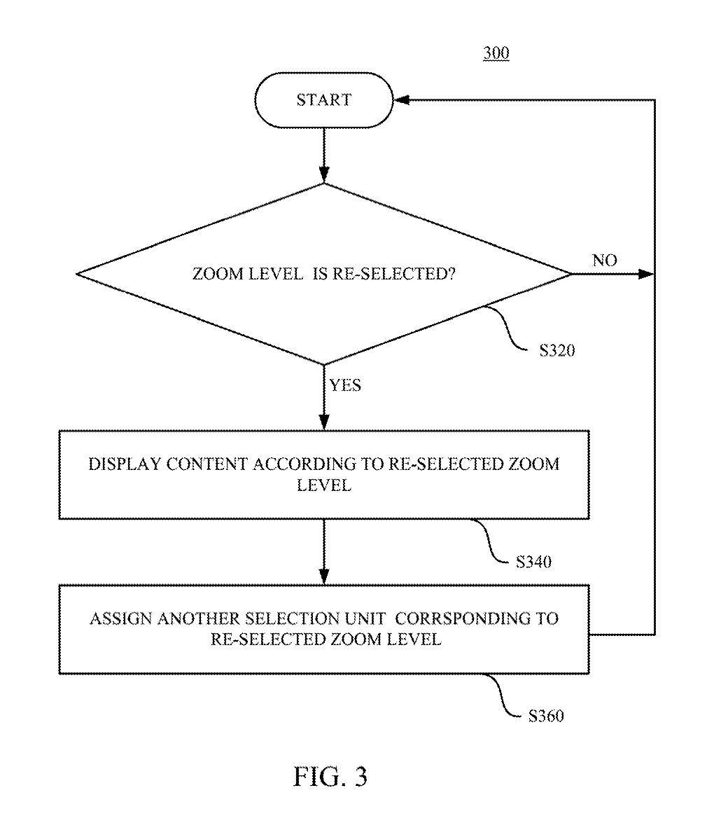

FIG. 3 is a flow chart of a touch selection method 300 according to an embodiment of the disclosure. FIG. 4A is a global view of an image 400 on the content 122 in FIG. 1 according to an embodiment of the disclosure. FIG. 4B is a partial enlarged view of the image 400 in FIG. 4A according to an embodiment of the disclosure. FIG. 4C is a local view of an image 400 in FIG. 4A according to an embodiment of the disclosure.

For illustration, the operations of the electronic apparatus 100 in FIG. 1 are described by the touch selection method 300 with reference to FIG. 3. As shown in FIG. 3, the touch selection method 300 includes operations S320, S340 and S360.

In operation S320, the processing unit 140 detects whether the zoom level F is re-selected. If the zoom level F is re-selected, operation S340 is performed. Alternatively, if the zoom level F is not re-selected, operation S320 is performed again.

In operation S340, the zoom level F is re-selected in response to the user input, and the display 120 displays the content 122 according to the re-selected zoom level F.

In operation S360, the processing unit 140 assigns another selection unit L corresponding to the re-selected zoom level F.

For illustration, as shown in FIG. 4A-4C, the content 122 includes an image 400, and the processing unit 140 adjusts the view of the image 400 in response to the user input. As illustrated in FIG. 4A, users are able to view the entire view of the image 400 in the global view. To view in more detail, users are able to perform the zoom-in operation to enlarge the view of the image 400, as illustrated in FIG. 4B. Further, to view in the most detailed view of the image 400, users are able to perform the zoom-in operation to view the image 400 in the local view, as illustrated in FIG. 4C.

When user performs the zoom-in operation on the image 400 from FIG. 4A to FIG. 4B, the processing unit 140 automatically assigns the smaller selection units L corresponding to the re-selected zoom level F. Alternatively, when user performs the zoom-out operation on the image 400 from the FIG. 4C to FIG. 4B, the processing unit 140 automatically assigns the larger selection units L corresponding to the re-selected zoom level F.

To be explained in detail, as illustrated in FIG. 4A, when viewing the image 400 in a global view (i.e., viewed with the minimum zoom level), the processing unit 140 assigns the objects of the image 400, such as person A1, closets A2 and A3, walls A4 and A5, and floor A6 as the selection units L by using a image recognition algorithm, etc. Thus, when user desires to select the person A1 in the image 400 in FIG. 4A, user is able to tap the person A1 by touching on the display 120. Alternatively, when the person A1 is selected, user is able to tap the person A1 by touching the display 120 to deselect the person A1.

In some embodiment, when user performs the zoom in operation to view the person A1 in detail, the processing unit 140 reselects the zoom level corresponding to the user input and re-assigns the selection units L as face B1, clothes B2, pants B3, shoes B4, etc, on the person A1.

Further, as illustrated in FIG. 4B, when viewing the image 400 in a partial enlarged view, the processing unit 140 segments the image 400 to assign the selection units L as regions on the image 400 by using a super pixel segmentation algorithm, or the like. Thus, when viewing the image in the partial enlarged view, users are able to select or deselect the regions of the image 400.

In some embodiments, as illustrated in FIG. 4B, users are able to select or deselect numerous selection units L by drawing a stroke 410 on the image 400. Thus, the selection units L being on the stroke 410 are thus selected or deselected.

Moreover, as illustrated in FIG. 4C, when viewing the image 400 in a local view (i.e., viewed with the maximum zoom level), the processing unit 140 further segments the image 400 to assign each pixel on the image 400 as the selection unit L. Users are thus able to perform the touch selection on the image 400 in a most detailed way.

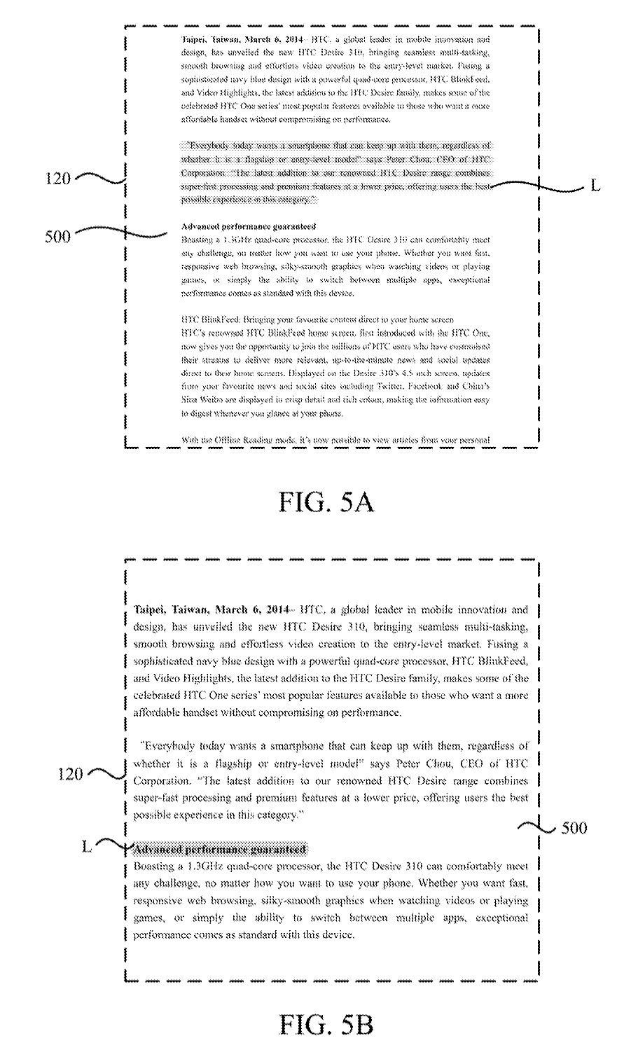

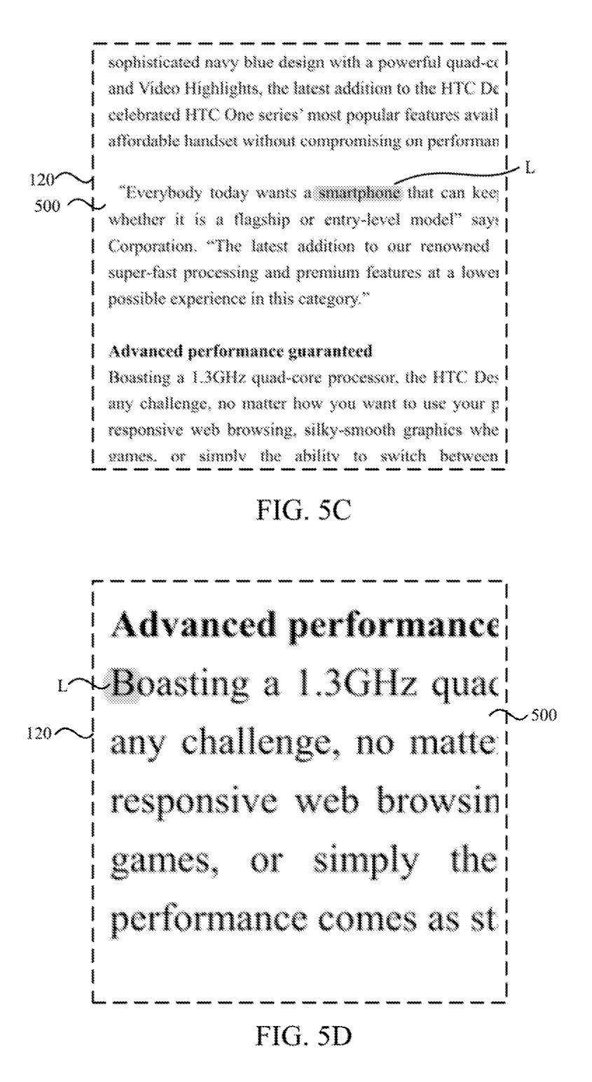

Reference is made to FIG. 5A-5D. FIG. 5A is a global view of a text 500 on the content 122 in FIG. 1 according to an embodiment of the disclosure. FIG. 5B is a partial enlarged view of the text 500 in FIG. 5A according to an embodiment of the disclosure. FIG. 5C is a further partial enlarged view of the text 500 in FIG. 5A according to an embodiment of the disclosure. FIG. 5D is a local view of the text 500 in FIG. 5A according to an embodiment of the disclosure.

In some embodiments, the content 122 includes a text 500, such as an article, a message, etc. In general, the text 500 is formed of characters, words, sentences and paragraphs. As illustrated in FIG. 5A, when user views the text 500 in a global view (i.e., view with minimum zoom level), the processing unit 140 assigns the selection unit L as a paragraph. Thus, when viewing the entire text 500, user is able to select or deselect the paragraph of the text 500 one by one.

Similarly, as illustrated in FIG. 5B, when user zooms in the text 500 from FIG. 5A to FIG. 5B to view the text 500, the processing unit 140 assigns the selection unit L as a sentence. When viewing the finger text 500, user is thus able to select each sentence of the text 500 by one tapping.

As illustrated in FIG. 5C, when user further zooms in the text 500 from the FIG. 5B to FIG. 5C, the processing unit 140 assigns the selection unit L as a word. When viewing the text 500 with an enlarged zoom factor, user is able to select the words of the text 500. Further, when viewing the text 500 in the most detailed view (i.e., view with maximum zoom level), the processing unit 140 assigns the selection unit L as a character. Thus, user is able to select each character of the text 500.

The above illustrations include exemplary operations, but the operations are not necessarily performed in the order shown. Operations may be added, replaced, changed order, and/or eliminated as appropriate, in accordance with the spirit and scope of various embodiments of the present disclosure.

In some embodiments, the selection unit L is able to be determined immediately after the zoom-in/out operation is performed. Alternatively, in some other embodiments, the selection units L corresponding to different zoom levels F are able to be predetermined and stored in a memory (not shown), and the processing unit 140 is able to select the corresponding size of the selection unit L from the memory when the zoom level is re-selected.

Furthermore, in various embodiments of the present disclosure, the touch selection method 300 is able to be implemented in terms of software, hardware and/or firmware. For instance, if the execution speed and accuracy have priority, then the touch selection method 300 is able to be implemented in terms of hardware and/or firmware. For illustration, if speed and accuracy are determined to be paramount, a hardware and/or firmware implementation is mainly selected and utilized. Alternatively, if flexibility is paramount, a software implementation is mainly selected and utilized. Furthermore, the touch selection method 300 may be implemented in terms of software, hardware and firmware in the same time. For illustration, the touch selection method 300 can be embodied on a non-transitory computer readable medium for execution by the processing unit 140 on the electronic apparatus 100.

It is noted that the foregoing examples or alternates should be treated equally, and the present disclosure is not limited to these examples or alternates. Person who has the ordinary skill in art can make modification to these examples or alternates in flexible way if necessary.

In summary, the electronic apparatus and the touch selection method of the present disclosure map the selection units to different zoom levels for preventing users from trivial tasks on multi-level selection. Users are thus able to be to select the desired objects in a more convenient way.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the invention. In view of the foregoing, it is intended that the present disclosure cover modifications and variations of this invention provided they fall within the scope of the following claims.

What is claimed is:

1. A method for performing a touch selection on a display, comprising:
assigning a selection unit corresponding to one of a plurality of zoom levels, wherein the selection unit comprises pixels on the display that are regarded as a minimum selectable component for the touch selection, the selection unit is different under the each of the zoom levels.

2. The method of claim 1, wherein the display is configured to display content, and the method further comprises:
selecting from the zoom levels in response to an user input as the one of the zoom levels.

3. The method of claim 2, when the one of the zoom level is re-selected, the method further comprises:
displaying the content according to the re-selected zoom level; and
assigning another selection unit corresponding to the re-selected zoom level.

4. The method of claim 1, wherein the display is configured to display content, and the content comprises an image, and the selection unit is assigned to be a pixel, a region, or an object of the image according to a scale of each zoom level.

5. The method of claim 4, wherein when the scale of the one of the zoom levels corresponds to a global view on the image, the selection unit is assigned to be the object, and when the scale of the one of the zoom levels corresponds to a local view on the image, the selection unit is assigned to be the pixel.

6. The method of claim 4, wherein when the scale of the one of the zoom levels corresponds to a view between a local view and a global view on the content, the selection unit is assigned to be the region.

7. The method of claim 1, wherein the display is configured to display content, and the content comprises a text, and the selection unit is assigned to be a paragraph, a sentence, a word, or a character of the text according to a scale of each zoom level.

8. The method of claim 7, wherein when the scale of the one of the zoom levels corresponds to a global view on the text, the selection unit is assigned to be the paragraph, and when the scale of the one of the zoom levels corresponds to a local view on the text, the selection unit is assigned to be the character.

9. The method of claim 7, wherein when the scale of the one of the zoom levels corresponds to a view between a local view and a global view on the text, the selection unit is assigned to be the sentence or the word.

10. An electronic apparatus, comprising:
a display configured to receive a touch selection; and
a processing unit configured to assign a selection unit corresponding to one of a plurality of zoom levels, wherein the selection unit comprises pixels on the display that are regarded as a minimum selectable component for the touch selection, and is different under the each of the zoom levels.

11. The electronic apparatus of claim 10, wherein the display is further configured to display content, and the processing unit is configured to select from the zoom levels in response to a user input as the one of the zoom levels.

12. The electronic apparatus of claim 11, wherein when the one of the zoom level is re-selected, the display is configured to display the content according to the re-selected zoom level, and the processing unit is configured to assign another selection unit corresponding to the re-selected zoom level.

13. The electronic apparatus of claim 10, wherein the display is further configured to display content, the content comprises an image, and the selection unit is assigned to be a pixel, a region, or an object of the image according to a scale of each zoom level.

14. The electronic apparatus of claim 13, wherein when the scale of the one of the zoom levels corresponds to a global view on the image, the selection unit is assigned to be the object, and when the scale of the re-selected zoom level corresponds to a local view on the image, the selection unit is assigned to be the pixel.

15. The electronic apparatus of claim 13, wherein when the scale of the one of the zoom levels corresponds to a view between a local view and a global view on the image, the selection unit is assigned to be the region.

16. The electronic apparatus of claim 10, wherein the display is further configured to display content, the content comprises a text, and the selection unit is assigned to be a paragraph, a sentence, a sentence, or a character of the text according to a scale of each zoom level.

17. The electronic apparatus of claim 16, wherein when the scale of the one of the zoom levels corresponds to a global view on the text, the selection unit is assigned to be the paragraph, and when the scale of the one of the zoom levels corresponds to a local view on the text, the selection unit is assigned to be the character.

18. The electronic apparatus of claim 16, wherein when the scale of the re-selected zoom level corresponds to a view between a local view and a global view on the text, the selection unit is assigned to be the sentence or the word.

19. A non-transitory computer readable medium having stored thereon executable instructions that when executed by the processor of a computer control the computer to perform steps comprising:
assigning a selection unit corresponding to one of a plurality of zoom levels, wherein the selection unit comprise pixels on a display that are regarded as a minimum selectable component for a touch selection.

20. The non-transitory computer readable medium of claim 19, wherein the display is configured to display a content, and the steps further comprise:
selecting from the zoom levels in response to a user input as the one of the zoom levels;
displaying the content according to the re-selected zoom level; and
assigning another selection unit corresponding to the re-selected zoom level.
